(19) United States
(12) Patent Application Publication
(10) Pub. No.: US 2010/0116896 A1
(43) Pub. Date: May 13, 2010

(54) THERMOSTAT APPARATUS INCLUDING CALIBRATION DEVICE

(75) Inventors: Wolfgang Goemann-Thoss, Hamburg (DE); Rainer Treptow, Norderstedt (DE); Melanie Persson, Hamburg (DE); Rudiger Huhn, Lubeck (DE); Th. Uschkureit, Henstedt-Ulzburg (DE)

Correspondence Address: RANKIN, HILL & CLARK LLP, 38210 Glenn Avenue, WILLOUGHBY, OH, 44094-7808, US

(73) Assignee: EPPENDORF AG, Hamburg (DE)

(21) Appl. No.: 12/523,606

(22) PCT Filed: Jan. 18, 2008
(86) PCT No.: PCT/EP08/00369

§ 371 Date: Nov. 30, 2009

(30) Foreign Application Priority Data
Jan. 19, 2007 (DE) 10 2007 003 754.8

(51) Int. Cl. G05D 23/19

(52) U.S. Cl. 236/91 R

(57) ABSTRACT

A thermostat apparatus is provided for simultaneous thermostatting of at least one sample that is contained, e.g., in sample vessels, having receptacles for receiving the samples or sample vessels, the apparatus having at least one thermostat device for generation of a desired temperature or temperature profile, having a control device for regulating the heating and/or cooling power of the at least one thermostat device, and having at least one regulating temperature sensor that is provided to determine a parameter that is indicative of the temperature and is connected to the control device. In addition to the at least one regulating temperature sensor, at least one calibrating temperature sensor is provided that is arranged in spatial proximity to an allocated regulating temperature sensor to determine a parameter that is indicative of the temperature, and is connected to the control device.

### BACKGROUND OF THE INVENTION

A thermostat apparatus of this type is known, e.g. from DE 196 46 115.4. Thermostat apparatuses of this design are typically used, e.g., for PCR. Other generic thermostat apparatuses are thermostats, work stations, and other apparatuses that can be used to simultaneously subject one or more samples to a temperature treatment. For this purpose, these apparatuses have one or more thermostat devices, occasionally one for each sample. In the following, reference is made mainly to so-called thermostat blocks for simultaneous thermostatting of at least one sample to illustrate the invention without wishing to limit the scope of the invention. Likewise, reference is always made in the following to the plural form of thermostat devices, samples, regulating temperature sensors, and calibrating temperature sensors without this meaning that the singular form thereof is excluded thereby.

For adjustment of the temperature, one or more thermostat devices are provided in the thermostat apparatus and the cooling and/or heating power of these thermostat devices is regulated by a control device. In addition, for this purpose, temperature sensors are provided in the vicinity of the sample, e.g. in or on the thermostat block in the case of thermostat blocks, which supply the measured temperature values to the control device which then triggers the thermostat devices on the basis of this data in order to make the nominal and the actual temperature match. For the temperature effected in the samples to match the true and/or desired temperature, it is of crucial significance that the temperature sensor or sensors used for regulating operate correctly and are positioned appropriately.

In particular in PCR, exact adherence to the desired temperature in the various stages of PCR is of enormous importance. Accordingly, there is an interest to check the quality of the thermostat blocks used for this purpose in regular intervals and remedy any deviations that are thus found. The term, calibration of the thermostat blocks, is used in this context. It means that the true temperature of the thermostat block is determined by means of measurements and the values thus determined are then compared to the nominal values the thermostat block should have according to predefinition and that were set by means of the regulating temperature sensors. Hereinafter, the term, calibrating, shall therefore mean the determination of a deviation between a set temperature value and the true value. Calibrating in itself does not yet involve an intervention that changes the apparatus.

It is known, according to the prior art, to make use of external calibrating temperature sensors for this purpose, that are typically inserted, e.g., in the sample receptacles provided on the top side of a generic thermostat block. The calibrating temperature sensors are to be connected, e.g., to an external measuring device or a PC with analytical software. The temperatures in different receptacles of the thermostat block are measured either simultaneously or sequentially and the predefined temperatures of the thermostat block are compared to the measured values of the external temperature sensors. Subsequently, it can be analyzed whether or not the thermostat block operates within a defined range of permissible variation.

Calibration systems according to the prior art are shown, e.g., in LaborMedizin & Diagnostik 03.04, pages 12 and 14. Moreover, a system of this type is known from www.cyclertester.com, and there is the Apollo validation system (see www.pretech.nu/products/Clp_Apollo_Tas16.htm).

This prior art is associated with various error sources that interfere with the measuring accuracy. Good thermal contact of the calibration temperature sensors to the thermostat block is especially critical. Poor contact means that the heat transfer from the block to the temperature sensor is poor also. Moreover, the calibration measurement is usually performed with the lid of the thermostat block being open, whereas an exact measurement would have to be performed under real PCR conditions with the lid being closed. It is also disadvantageous that the application of the known calibration systems is not very convenient. In addition to this application being unreliable and error-prone, calibration according to the prior art is quite time-consuming. The users may fail to comply with the desired regular checking of the thermostat block, e.g. at fixed check intervals (e.g. at fixed times or after a predefined number of cycles).

### BRIEF SUMMARY OF THE INVENTION

It is therefore the object of the present invention to further develop a generic thermostat apparatus such that the above-mentioned disadvantages of the prior art are remedied.

According to the invention, the thermostat apparatus is provided to include one or more calibrating temperature sensor(s) that detect(s) the temperature of the thermostat apparatus. For this purpose, they are arranged in spatial vicinity to allocated regulating temperature sensors and determine a parameter that is indicative of the temperature (resistance, voltage, radiation, etc.). Accordingly, the calibrating temperature sensor(s) supply/supplies measured temperature values (or values that allow conclusions regarding the temperature to be made) that can be compared to the measured values of the regulating temperature sensor(s) or parameters derived therefrom or filed nominal values. The control device is designed to perform this type of comparison. The comparison can be used to determine whether or not the thermostat apparatus still sets the desired temperatures reliably and/or whether or not the regulating temperature sensors still operate properly. If a strong deviation is evident, for example the control device can output an error message or prevent the further use of the thermostat block. External calibrating temperature sensors are no longer needed; the internal calibrating temperature sensors described above must still be referenceable to external standards (NIST). For this purpose, they are checked, e.g., once annually.

The control device may just as well consist of multiple control units of which one is arranged in a measuring circuit for the regulating temperature sensors and another is arranged in a measuring circuit for the calibrating temperature sensors.

Additional advantageous further embodiments of the invention are the subject of the dependent claims. Accordingly, the thermostat apparatus is provided to comprise a thermostat block.

In this context, it is proposed that multiple calibrating temperature sensors are distributed over the thermostat block and are in a measuring contact with the thermostat block. This renders it feasible, e.g., to also compare the calibrating temperature sensors to each other, e.g. in order to determine deviations or errors of these sensors. Moreover, this also renders it feasible, e.g., to generate a temperature profile in the thermostat block and to calibrate the reliable generation thereof.

One calibrating temperature sensor could be allocated to multiple thermostat devices in groups. However, it is preferred for the number of calibrating temperature sensors to be equal to the number of regulating temperature sensors. In this case, one calibrating temperature sensor can be allocated to each regulating temperature sensor such that each regulating temperature sensor can be checked individually for correct function and replaced, if needed.

The calibration modus can be triggered automatically by the control device, e.g. in a time-dependent fashion, e.g. daily. The modus can be triggered just as well, e.g., after a certain number of temperature cycles or temperature changes; this number could, e.g., be changeable, for example by an operator. This is advantageous in that the thermostat apparatus is subjected to a calibration reliably and in a defined rhythm.

Moreover, it is also advantageous that the calibration modus can be initiated manually in case of need. For example, if the results appear to be unusual, a calibration can be performed in order to exclude that this is related to erroneous thermostatting of the samples.

It is advantageous to save the results of the temperature sensors, that is both the results of the regulating temperature sensors and those of the calibrating temperature sensors. Alternatively or in addition, the result of the comparison of the sensor values can be saved in a memory, e.g. differences or quotients. These values can advantageously be read-out or out-put by means of an interface, e.g. to a printer or a monitor. This can happen either directly or from the memory after saving. It is also feasible to transmit this data to an external computer or data carrier for further analysis.

The calibrating temperature sensor is provided to be replaceable in order to be able to replace damaged sensors, for example.

The thermostat apparatus advantageously includes a sensor that measures the ambient temperature. By this means it can be determined whether or not the thermostat apparatus was used outside the permissible temperature range.

On principle, the calibrating temperature sensors can be provided to be identical to the regulating temperature sensors. However, it is advantageous for the reliability and significance of the calibration that the calibrating temperature sensors have at least the same, or better—an even higher, measuring accuracy as/than the regulating temperature sensors. Moreover, they should have good measuring stability over time.

Measuring deviations that are determined can be remedied by regulating temperature sensors by utilizing the values of the calibrating temperature sensors to adjust the regulating temperature sensors. The conversion of the values supplied by the regulating temperature sensors into temperatures could, e.g., be changed until they match the values of the calibrating temperature sensors.

It is advantageous to provide for the calibrating temperature sensors to monitor the adherence to a maximal or minimal temperature. The data of the calibrating temperature sensors are used by the control system to recognize that the limit temperatures have been reached and to turn-off or downregulate the heating or cooling power of the thermostat devices before, e.g., the thermostat apparatus is damaged or the sample vessels or the samples contained therein are damaged by excessive heating.

The calibrating temperature sensors can, e.g., be arranged in a fixed fashion in the thermostat apparatus, e.g. they can be firmly connected to a thermostat block. However, it is advantageous to provide for the calibrating temperature sensors to be automatically moveable from a measuring position to a resting position and vice versa. This improves the consistency over time since the sensors are at higher temperatures for a shorter period of time. In addition, they are thus more easy to replace.

### BRIEF DESCRIPTION OF THE DRAWINGS

The figures show the invention in an exemplary and schematic fashion. The exemplary embodiments shown are to illustrate the invention in more detail. The invention is illustrated by means of thermostat blocks without limiting its generality. In the figures:

FIG. 1 shows a schematic side view of a thermostat block according to the prior art;

FIG. 2 shows a bottom view of a generic thermostat block;

FIG. 3 shows a bottom view of an exemplary embodiment of a thermostat block according to the invention with thermostat devices being omitted;

FIG. 4 shows a view according to FIG. 3 of a second exemplary embodiment of a thermostat block according to the invention, and

FIG. 5 shows a flow diagram of the functional principle of an exemplary embodiment of a thermostat block according to the invention.

### DETAILED DESCRIPTION OF THE INVENTION

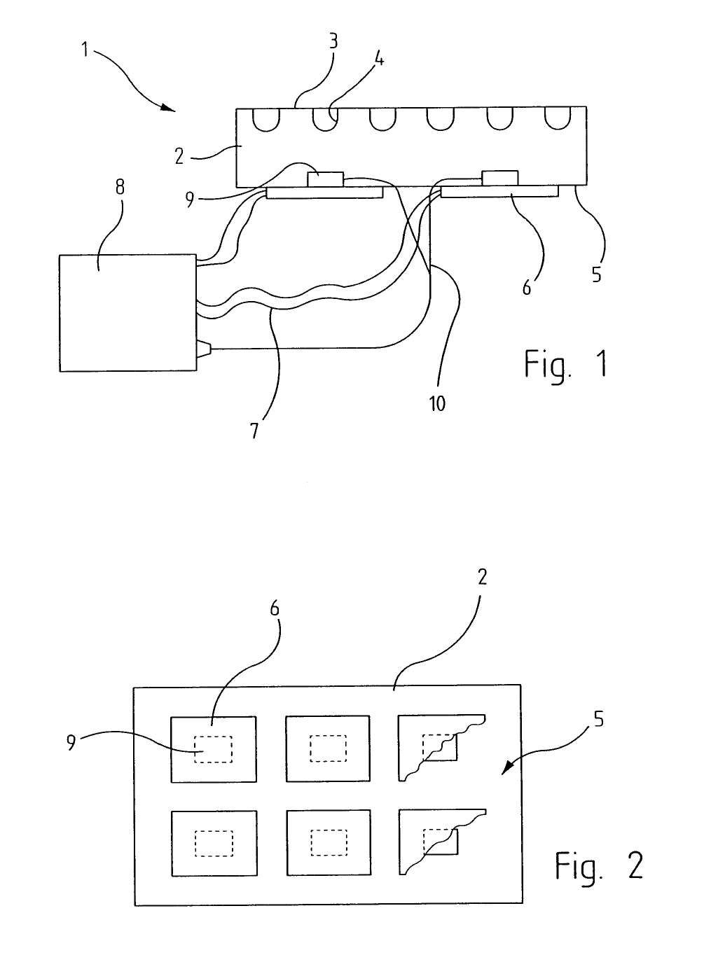

The thermostat block 1 of FIG. 1 consists of a block 2 made of a good heat-conducting material on the top side 3 of which multiple receptacles 4 for the reception of sample vessels that are not shown are provided. Two Peltier elements 6 serving as thermostat devices are arranged in series on the contacting side 5 that is situated opposite to this receptacle side 4. These thermostat devices 6 are connected by means of lines 7 to the control device 8 that controls the heating or cooling power of the Peltier elements 6.

Situated above each of the Peltier elements 6 and countersunk in block 2, a regulating temperature sensor 9 measures the temperature of the block 2 at this location. The temperature values thus measured and/or values that are indicative of the temperature are transmitted via a measuring or data line 10 to the control device 8.

The temperature sensor can, e.g., be a PT100 temperature probe. The prior art knows numerous alternatives to this, e.g. semi-conductor temperature sensors, heat probes having piezoelectric quartz resonators as measuring elements, thermo-elements, pyrometric sensors, etc.

For regulating the temperature of the block 2, the control device 8 controls the Peltier elements 6 as a function of the values supplied by the regulating temperature sensor 9. For example, if the values indicate that the temperature reached is lower than the temperature to be set, the control device 8 proceeds to increase the heating power of the Peltier elements 6.

FIG. 2 shows the block 2 of FIG. 1 in a schematic bottom view. In this example, six Peltier elements 6 touch on the contacting side 5 of the block 2 in a heat-conducting fashion. Above each of these Peltier elements, a regulating temperature sensor is arranged whose values are used to control the Peltier elements by the control device that is not shown in FIG. 2.

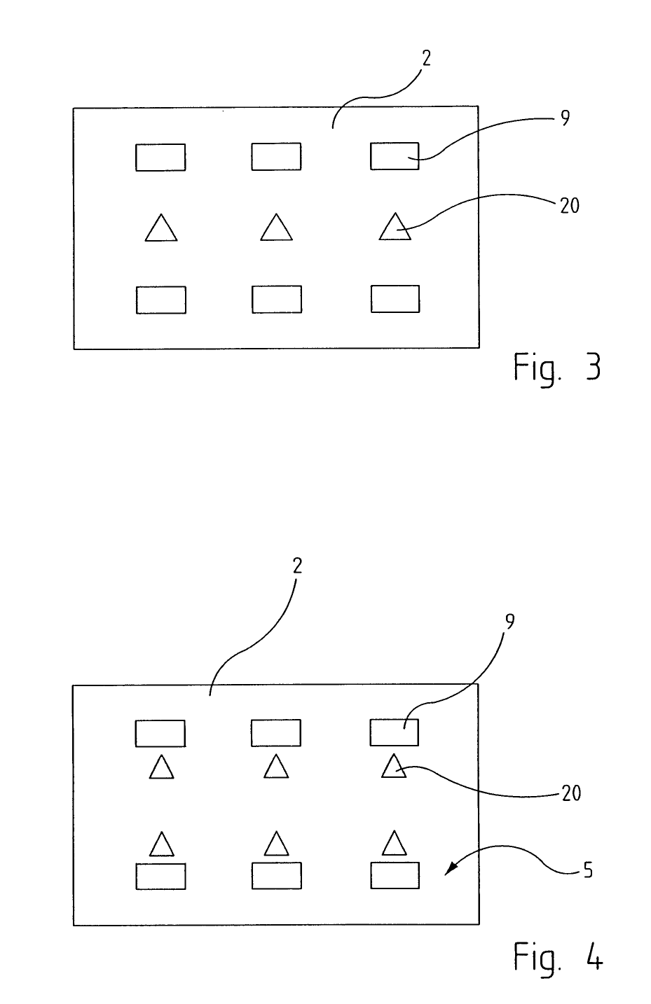

FIG. 3 shows the six regulating temperature sensors that are countersunk into the block 2 in a view like in FIG. 2 with thermostat devices being omitted. In addition, calibrating temperature sensors shown as triangles are arranged on the contacting side of the block 2. In the exemplary embodiment shown, each pair of thermostat devices 6 has a calibrating temperature sensor 20 allocated to it that is situated approximately in the middle between the two thermostat devices.

In the exemplary embodiment shown in FIG. 4, each of the regulating temperature sensors 9 has its own calibrating temperature sensor 20 allocated to it in immediate spatial proximity. Accordingly, without limiting the generality, six regulating temperature sensors and six calibrating temperature sensors are provided on the contacting side 5 of the block 2.

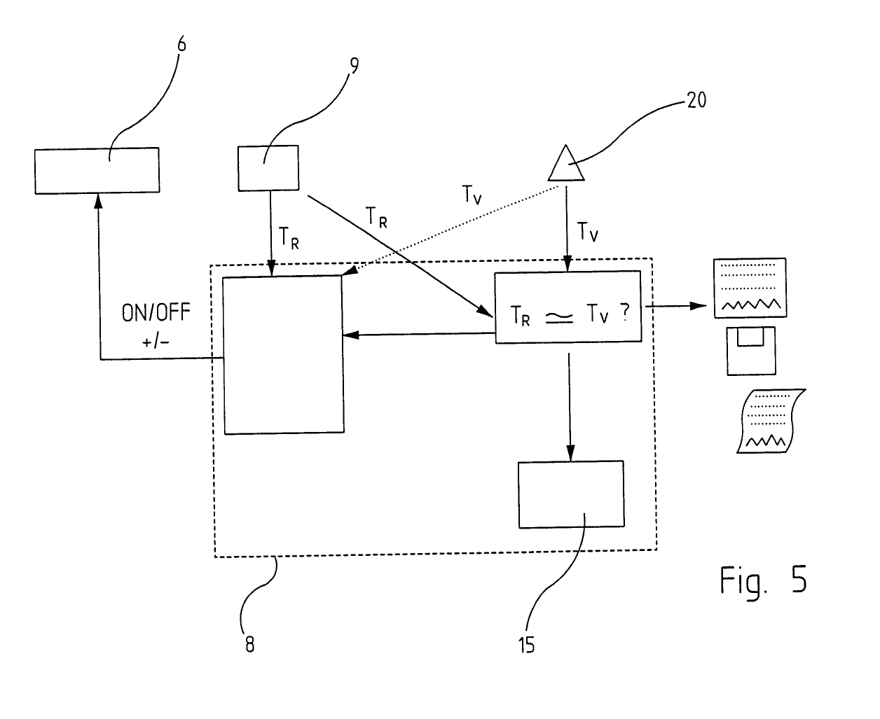

FIG. 5 schematically shows the function of a thermostat block according to the invention. The control device 8 receives from regulating temperature sensor 9 temperature values T_{R} and/or values that are indicative of the temperature. The thermostat device 6 is controlled as a function of these temperature values T_{R}, i.e. it is controlled, e.g., towards higher or lower heating power (+/−) or switched on or off (on/off).

In addition, in a calibration mode, temperature data T_{V} and/or values that are indicative of the temperature that are received from the calibrating temperature sensor 20 can be compared to the values that are supplied to the control device 8 by regulating temperature sensor 9. The measured values T_{R} and T_{V} can be filed, e.g., in a memory 15. In addition or alternatively, data derived therefrom by analysis, such as, e.g., differences or quotients, can also be filed.

In as far as this is desired, the regulating temperature sensors can be adjusted by means of the calibrating temperature sensors. For this purpose, e.g., the values of the regulating temperature sensors are corrected until a match to the calibrating temperature sensor within a defined range of permissible tolerance is achieved.

By means of an interface, the measuring data or data obtained therefrom can be displayed on a monitor, saved on a data carrier or printed out.

In a further development, the control device 8 utilizes measured values of the calibrating temperature sensor 20 for monitoring to ensure that no critical values are exceeded or not reached. Subsequently, the measured values of the calibrating temperature sensor are checked for whether or not a critical temperature is about to be exceeded or not reached. If a critical status of this type is imminent, the control device 8 down-regulates the thermostat devices 6.

1-27. (canceled)

28. Thermostat apparatus (1) for simultaneous thermostatting of at least one sample that is contained, e.g., in sample vessels, comprising:
receptacles (4) for receiving the samples or sample vessels,
at least one thermostat device (6) for generation of a desired temperature or temperature profile,
a control device (8) for regulating the heating and/or cooling power of the at least one thermostat device (6), and
at least one regulating temperature sensor (9) that is provided to determine a parameter that is indicative of the temperature and is connected to the control device (8),
wherein in addition to the at least one regulating temperature sensor (9) at least one calibrating temperature sensor (20) is provided to determine a parameter that is indicative of the temperature and is connected to the control device (8),
wherein the control device (8), in a calibration mode, is provided for comparing the parameter that is indicative of the temperature and is determined by the at least one calibrating temperature sensor (20) and the parameter that is indicative of the temperature and is determined by the regulating temperature sensor (9) or for comparing parameters derived therefrom or to nominal values, and for putting out an error message or for preventing the further use of the thermostat apparatus, if a strong deviation is evident by the comparison performed by the control device (8).

29. Thermostat apparatus (1) for simultaneous thermostatting of at least one sample that is contained, e.g., in sample vessels, comprising:
receptacles (4) for receiving the samples or sample vessels,
at least one thermostat device (6) for generation of a desired temperature or temperature profile,
a control device (8) for regulating the heating and/or cooling power of the at least one thermostat device (6), and
at least one regulating temperature sensor (9) that is provided to determine a parameter that is indicative of the temperature and is connected to the control device (8),
wherein in addition to the at least one regulating temperature sensor (9), at least one calibrating temperature sensor (20) is provided to determine a parameter that is indicative of the temperature and is connected to the control device (8),
wherein the control device (8), in a calibration mode, is provided for comparing the parameter that is indicative of the temperature and is determined by the at least one calibrating temperature sensor (20) and the parameter that is indicative of the temperature and is determined by the regulating temperature sensor (9) or for comparing parameters derived therefrom or to nominal values, and for adjusting the regulating temperature sensors (9) according to the calibrating temperature sensors (20).

30. Thermostat apparatus (1) according to claim 29, wherein for adjusting the regulating temperature sensors (9), the values of the regulating temperature sensors (9) are corrected until a match to the calibrating temperature sensors (20) within a defined range of permissible tolerance is achieved.

31. Thermostat apparatus (1) according to claim 29, wherein for adjusting the regulating temperature sensors (9), the conversion of the values supplied by the regulating temperature sensors (9) into temperatures is changed until they match the values of the calibrating temperature sensors (20).

32. Themostat apparatus according to claim 28, further comprising a thermostat block (2) on the reception side (3) of which the receptacles (4) are provided, and on the contacting side (5) of which, being opposite of the reception side (3), multiple thermostat devices (6) are arranged such as to be in thermal contact.

33. Thermostat apparatus according to claim 32, wherein multiple calibrating temperature sensors (20) are in thermal contact with the thermostat block (2) and are arranged so as to be distributed over the thermostat block.

34. Thermostat apparatus according to claim 28, wherein the number of calibrating temperature sensors (20) is equal to the number of regulating temperature sensors (9) and one calibrating (20) and one regulating temperature sensor (9) each are allocated to each other.

35. Thermostat apparatus according to claim 28 wherein the control device (8) triggers the calibration mode automatically.

36. Thermostat apparatus according to claim 35, wherein the control device (8) triggers the calibration mode automatically in a time-dependent fashion.

37. Thermostat apparatus according to claim 35, wherein the control device (8) triggers the calibration mode automatically after a certain number of temperature cycles or temperature changes.

38. Thermostat apparatus according to claim 37, wherein the number of temperature cycles or temperature changes is changeable.

39. Thermostat apparatus according to claim 28, wherein the calibration mode can be triggered manually by an operator.

40. Thermostat apparatus according to claim 28, wherein the results of the calibrating temperature sensors (20) and of the regulating temperature sensors (9) and/or results determined therefrom, e.g. differences or quotients, are filed in a memory.

41. Thermostat apparatus according to claim 28, wherein the apparatus comprises an interface for read-out or output of the measured values of the temperature sensors (9, 20).

42. Thermostat apparatus according to claim 28, wherein the calibrating temperature sensors (20) are provided to be replaceable.

43. Thermostat apparatus according to claim 28, wherein an ambient temperature sensor is provided that is provided to measure the ambient temperature of the thermostat apparatus (1).

44. Thermostat apparatus according to claim 28, wherein the control device (8) is provided so as to monitor adherence to a maximal or minimal temperature during the operation of the thermostat apparatus (1) based on the data of the calibrating temperature sensors (20), and to turn off the heating/cooling power of the thermostat devices (6) when this temperature is reached.
